(19) United States
(12) Patent Application Publication
(10) Pub. No.: US 2014/0304586 A1
(43) Pub. Date: Oct. 9, 2014

(54) ELECTRONIC DEVICE AND DATA PROCESSING METHOD

(71) Applicant: KABUSHIKI KAISHA TOSHIBA, Tokyo (JP)

(72) Inventor: Hirotada Hirabayashi, Hamura-shi (JP)

(73) Assignee: KABUSHIKI KAISHA TOSHIBA, Tokyo (JP)

(21) Appl. No.: 14/068,526

(22) Filed: Oct. 31, 2013

(30) Foreign Application Priority Data
Apr. 4, 2013 (JP) 2013-078619

(51) Int. Cl. G06F 17/21

(52) U.S. Cl. CPC G06F 17/211
USPC 715/234; 715/277

(57) ABSTRACT

According to one embodiment, an electronic device acquires a file, and displays a page on a screen, based on layer information in the file. The file includes first and second layer information. The first layer information includes handwritten data including a plurality of stroke data, a first character string corresponding to the plurality of stroke data, and first information designating a first display area on the page for displaying the first character string or the plurality of the stroke data. The second layer information includes information for displaying content data, a second character string corresponding to the content data, and second information designating a second display area on the page for displaying the second character string or the content data.

### CROSS-REFERENCE TO RELATED APPLICATIONS

This application is based upon and claims the benefit of priority from Japanese Patent Application No. 2013-078619, filed Apr. 4, 2013, the entire contents of which are incorporated herein by reference.

### FIELD

Embodiments described herein relate generally to a technique of processing handwritten data.

### BACKGROUND

In recent years, various kinds of electronic devices, such as a tablet, a PDA and a smartphone, have been developed. Most of these electronic devices include touch-screen displays for facilitating input operations by users.

By touching a menu or an object, which is displayed on the touch-screen display, by a finger or the like, the user can instruct an electronic device to execute a function which is associated with the menu or object.

However, most of existing electronic devices with touch-screen displays are consumer products which are designed to enhance operability on various media data such as video and music, and are not necessarily suitable for use in a business situation such as a meeting, a business negotiation or product development. Thus, in business situations, paper-based pocket notebooks have still been widely used.

Recently, a technique for handling a plurality of documents as one collection has also been developed.

However, in some cases, the conventional document data format for handling handwritten data is not adequate with respect to compatibility.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic device according to an embodiment.

FIG. 2 is an exemplary view illustrating a cooperative operation between the electronic device of the embodiment and an external apparatus.

FIG. 3 is a view illustrating an example of a handwritten document which is handwritten on a touch-screen display of the electronic device of the embodiment.

FIG. 4 is an exemplary view for explaining time-series information corresponding to the handwritten document of FIG. 3, the time-series information being stored in a storage medium by the electronic device of the embodiment.

FIG. 5 is an exemplary block diagram illustrating a system configuration of the electronic device of the embodiment.

FIG. 6 is an exemplary block diagram illustrating a functional configuration of a digital notebook application program which is executed by the electronic device of the embodiment.

FIG. 7 is a view illustrating an example of a handwritten page which is displayed on the screen by the electronic device of the embodiment.

FIG. 8 is an exemplary view for explaining the data structure of the handwritten page of FIG. 7.

FIG. 9 is a view illustrating an example of a class diagram corresponding to the data structure of FIG. 8.

FIG. 10 is a view illustrating an example of an XML file corresponding to the handwritten page of FIG. 7.

FIG. 11 is an exemplary flowchart illustrating the procedure of a display process which is executed by the electronic device of the embodiment.

### DETAILED DESCRIPTION

Various embodiments will be described hereinafter with reference to the accompanying drawings.

In general, according to one embodiment, an electronic device includes a processor and a display processor. The processor is configured to acquire a file comprising layer information. The display processor is configured to display a page on a screen, based on the layer information. The file includes at least first layer information and second layer information. The first layer information includes handwritten data including a plurality of stroke data, a first character string corresponding to the plurality of stroke data, and first information designating a first display area on the page, the first character string or the plurality of the stroke data displayed on the first display area. The second layer information includes information for displaying content data which differs in kind of content from the handwritten data, a second character string corresponding to the content data, and second information designating a second display area on the page, the second character string or the content data displayed on the second display area.

FIG. 1 is a perspective view illustrating an external appearance of an electronic device according to an embodiment. The electronic device is, for instance, a pen-based portable electronic device which can execute a handwriting input by a pen or a finger. This electronic device may be realized as a tablet computer, a notebook-type personal computer, a smartphone, a PDA, etc. In the description below, the case is assumed that this electronic device is realized as a tablet computer 10. The tablet computer 10 is a portable electronic device which is also called “tablet” or “slate computer”. As shown in FIG. 1, the tablet computer 10 includes a main body 11 and a touch-screen display 17. The touch-screen display 17 is attached such that the touch-screen display 17 is laid over the top surface of the main body 11.

The main body 11 has a thin box-shaped housing. In the touch-screen display 17, a flat-panel display and a sensor, which is configured to detect a touch position of a pen or a finger on the screen of the flat-panel display, are assembled. The flat-panel display may be, for instance, a liquid crystal display (LCD). As the sensor, for example, use may be made of an electrostatic capacitance-type touch panel, or an electromagnetic induction-type digitizer. In the description below, the case is assumed that two kinds of sensors, namely a digitizer and a touch panel, are both assembled in the touch-screen display 17.

Each of the digitizer and the touch panel is provided in a manner to cover the screen of the flat-panel display. The touch-screen display 17 can detect not only a touch operation on the screen with use of a finger, but also a touch operation on the screen with use of a pen 100. The pen 100 may be, for instance, an electromagnetic-induction pen. The user can execute a handwriting input operation on the touch-screen display 17 by using an external object (pen 100 or finger). During the handwriting input operation, a locus of movement of the external object (pen 100 or finger) on the screen, that is, a stroke which has been handwritten by the handwriting input operation (a locus of a handwritten stroke), is drawn in real time, and thereby a plurality of handwritten strokes which have been input by handwriting (the locus of each handwritten stroke) are displayed on the screen. A locus of movement of the external object during a time in which the external object is in contact with the screen corresponds to one handwritten stroke. A set of many handwritten strokes corresponding to handwritten characters, marks, graphics, tables, etc., that is, a set of many loci (traces of writing), constitutes handwritten data. In the description below, the handwritten stroke is also referred to simply as “stroke”.

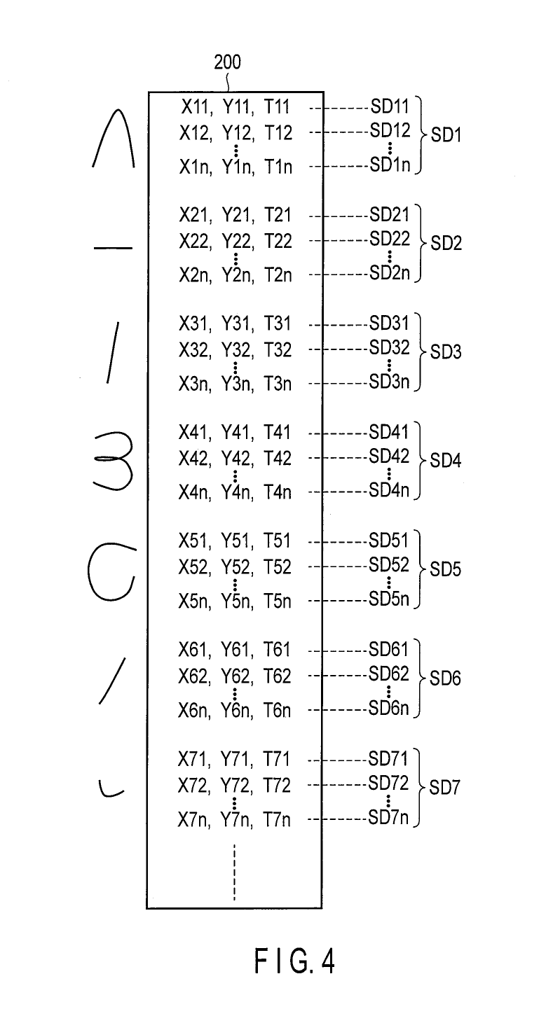

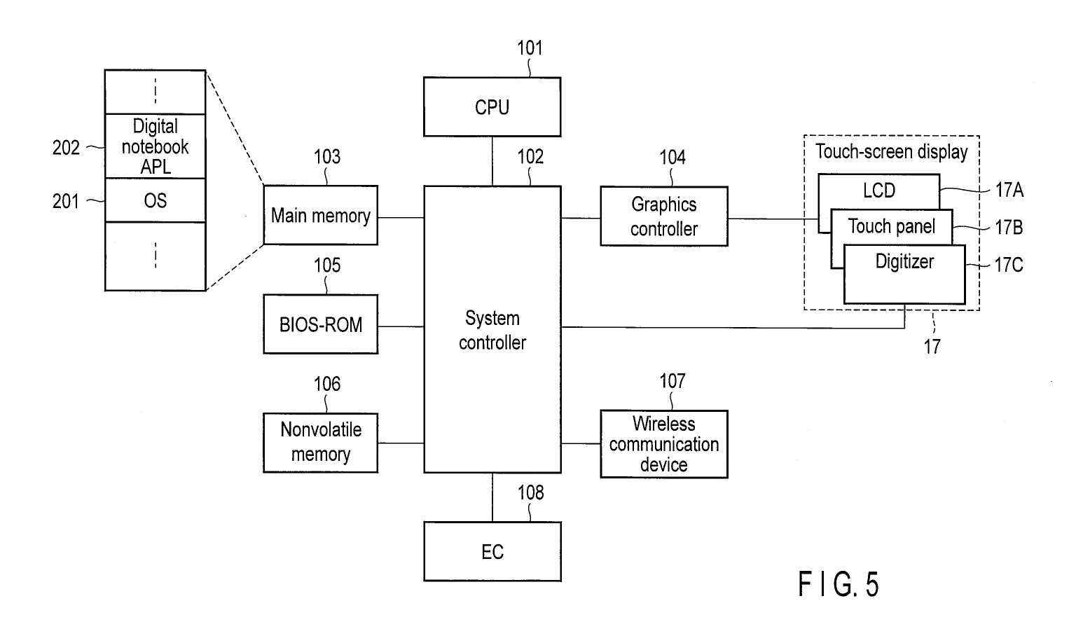

In the present embodiment, this handwritten document is stored in a storage medium not as image data but as time-series information indicative of coordinate series of the loci of strokes and the order relation between the strokes. The details of this time-series information will be described later with reference to FIG. 4. This time-series information indicates an order in which a plurality of strokes are handwritten, and includes a plurality of stroke data corresponding to a plurality of strokes. In other words, the time-series information means a set of time-series stroke data corresponding to a plurality of strokes. Each stroke data corresponds to one stroke, and includes coordinate data series (time-series coordinates) corresponding to points on the locus of this stroke. The order of arrangement of these stroke data corresponds to an order in which strokes are handwritten, that is, an order of strokes.

The tablet computer 10 can read out arbitrary existing time-series information from the storage medium, and can display on the screen a handwritten document corresponding to this time-series information, that is, a plurality of strokes indicated by this time-series information. A plurality of strokes indicated by the time-series information are also a plurality of strokes which are input by handwriting.

Furthermore, the tablet computer 10 has an edit function. The edit function can delete or move an arbitrary stroke or an arbitrary handwritten object part (a handwritten character, a handwritten mark, a handwritten graphic, a handwritten table, etc.) in the displayed handwritten document, in accordance with an edit operation by the user with use of an “eraser” tool, a range select tool, and other various tools.

In this embodiment, the time-series information (handwritten document) may be managed as one page or plural pages. In this case, the time-series information (handwritten document) may be divided in units of an area which falls within one screen, and thereby a piece of time-series information, which falls within one screen, may be stored as one page. Alternatively, the size of one page may be made variable. In this case, since the size of a page can be increased to an area which is larger than the size of one screen, a handwritten document of an area larger than the size of the screen can be handled as one page. When one whole page cannot be displayed on the display at a time, this page may be reduced in size and displayed, or a display target part in the page may be moved by vertical and horizontal scroll.

A page may include not only a handwritten document (handwritten data), but also various content data other than handwritten data, such as image data (still image, moving picture), text data, audio data, and data created by a drawing application. In other words, the handwritten document (handwritten page data), which is handled in the embodiment, may include plural kinds of media data (e.g. handwritten data, image data, text data, audio data, and data created by a drawing application). In this case, mutually different layers are allocated to these media data included in the handwritten page data. The user can handwrite strokes (a handwritten character, a handwritten mark, a handwritten graphic, a handwritten table, etc.) on certain media data (also referred to as “content data”).

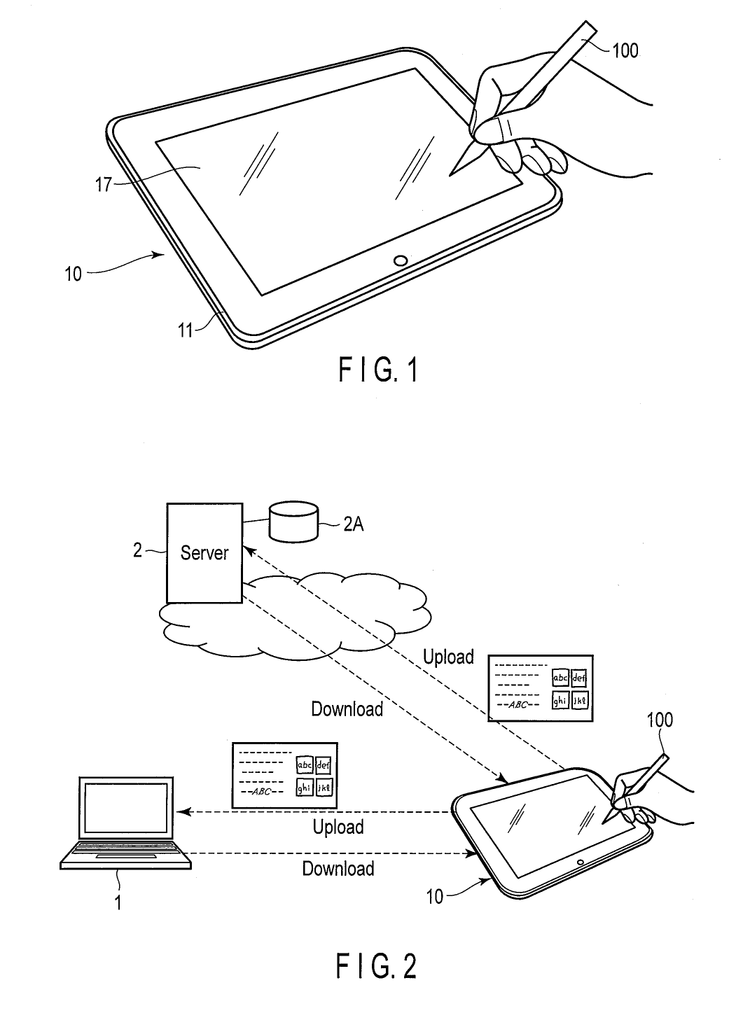

FIG. 2 shows an example of a cooperative operation between the tablet computer 10 and an external apparatus. The tablet computer 10 can cooperate with a personal computer 1 or a cloud. Specifically, the tablet computer 10 includes a wireless communication device of, e.g. wireless LAN, and can wirelessly communicate with the personal computer 1. Further, the tablet computer 10 can communicate with a server 2 on the Internet. The server 2 may be a server which executes an online storage service, and other various cloud computing services.

The personal computer 1 includes a storage device such as a hard disk drive (HDD). The tablet computer 10 can transmit handwritten page data to the personal computer 1 over a network, and can store the handwritten page data in the HDD of the personal computer 1 (“upload”). In order to ensure a secure communication between the tablet computer 10 and personal computer 1, the personal computer 1 may authenticate the tablet computer 10 at a time of starting the communication. In this case, a dialog for prompting the user to input an ID or a password may be displayed on the screen of the tablet computer 10, or the ID of the tablet computer 10, for example, may be automatically transmitted from the tablet computer 10 to the personal computer 1.

Thereby, even when the capacity of the storage in the tablet computer 10 is small, the tablet computer 10 can handle many handwritten page data or large-volume handwritten page data.

In addition, the tablet computer 10 can read out (“download”) one or more arbitrary handwritten page data stored in the HDD of the personal computer 1, and can display the content of the handwritten page data (handwritten data, and other various kinds of content data) on the screen of the display 17 of the tablet computer 10. In this case, the tablet computer 10 may display on the screen of the display 17 a list of thumbnails which are obtained by reducing in size pages of plural handwritten page data, or may display one page, which is selected from these thumbnails, on the screen of the display 17 in the normal size.

Furthermore, the destination of communication of the tablet computer 10 may be not the personal computer 1, but the server 2 on the cloud which provides storage services, etc., as described above. The tablet computer 10 can transmit handwritten page data to the server 2 over the network, and can store the handwritten page data in a storage device 2A of the server 2 (“upload”). Besides, the tablet computer 10 can read out arbitrary handwritten page data which is stored in the storage device 2A of the server 2 (“download”) and can display the content of the handwritten page data (handwritten data, and other various kinds of content data) on the screen of the display 17 of the tablet computer 10.

As has been described above, in the present embodiment, the storage medium in which the handwritten page data is stored may be the storage device in the tablet computer 10, the storage device in the personal computer 1, or the storage device in the server 2.

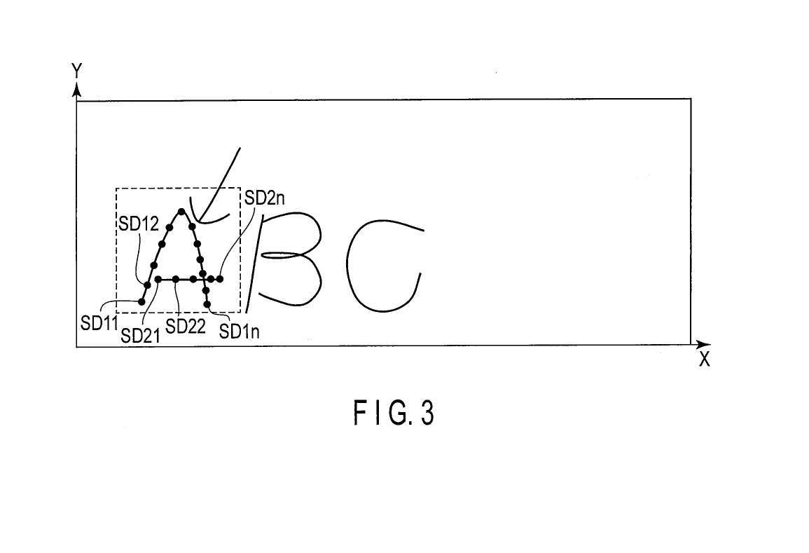

Next, referring to FIG. 3 and FIG. 4, a description is given of a relationship between strokes (characters, marks, graphics, tables, etc.), which are handwritten by the user, and time-series information. FIG. 3 shows an example of a handwritten document (handwritten character string) which is handwritten on the touch-screen display 17 by using the pen 100 or the like.

In many cases, on a handwritten document, other characters or graphics are handwritten over already handwritten characters or graphics. In FIG. 3, the case is assumed that a handwritten character string “ABC” was handwritten in the order of “A”, “B” and “C”, and thereafter a handwritten arrow was input by handwriting near the handwritten character “A”.

The handwritten character “A” is expressed by two strokes (a locus of “Λ” shape, a locus of “-” shape) which are handwritten by using the pen 100 or the like, that is, by two loci. The locus of the pen 100 of the first handwritten “Λ” shape is sampled in real time, for example, at regular time intervals, and thereby time-series coordinates SD11, SD12, . . . , SD1n of the stroke of the “Λ” shape are obtained. Similarly, the locus of the pen 100 of the next handwritten “-” shape is sampled in real time, for example, at regular time intervals, and thereby time-series coordinates SD21, SD22, . . . , SD2n of the stroke of the “-” shape are obtained.

The handwritten character “B” is expressed by two strokes which are handwritten by using the pen 100 or the like, that is, by two loci. The handwritten character “C” is expressed by one stroke which is handwritten by using the pen 100 or the like, that is, by one locus. The handwritten “arrow” is expressed by two strokes which are handwritten by using the pen 100 or the like, that is, by two loci.

FIG. 4 illustrates time-series information (handwritten data) 200 corresponding to the handwritten document of FIG. 3. The time-series information 200 includes a plurality of stroke data SD1, SD2, . . . , SD7. In the time-series information 200, the stroke data SD1, SD2, . . . , SD7 are arranged in time series in the order of strokes, that is, in the order in which plural strokes are handwritten.

In the time-series information 200, the first two stroke data SD1 and SD2 are indicative of two strokes of the handwritten character “A”. The third and fourth stroke data SD3 and SD4 are indicative of two strokes which constitute the handwritten character “B”. The fifth stroke data SD5 is indicative of one stroke which constitutes the handwritten character “C”. The sixth and seventh stroke data SD6 and SD7 are indicative of two strokes which constitute the handwritten “arrow”.

Each stroke data includes coordinate data series (time-series coordinates) corresponding to one stroke, that is, a plurality of coordinates corresponding to a plurality of points on the locus of one stroke. In each stroke data, the plural coordinates are arranged in time series in the order in which the stroke is written. For example, as regards handwritten character “A”, the stroke data SD1 includes coordinate data series (time-series coordinates) corresponding to the points on the locus of the stroke of the “Λ” shape of the handwritten character “A”, that is, an n-number of coordinate data SD11, SD12, . . . , SD1n. The stroke data SD2 includes coordinate data series corresponding to the points on the locus of the stroke of the “-” shape of the handwritten character “A”, that is, an n-number of coordinate data SD21, SD22, . . . , SD2n. Incidentally, the number of coordinate data may differ between respective stroke data.

Each coordinate data is indicative of an X coordinate and a Y coordinate, which correspond to one point in the associated locus. For example, the coordinate data SD11 is indicative of an X coordinate (X11) and a Y coordinate (Y11) of the starting point of the stroke of the “Λ” shape. The coordinate data SD1n is indicative of an X coordinate (X1n) and a Y coordinate (Y1n) of the end point of the stroke of the “Λ” shape.

Further, each coordinate data may include time stamp information T corresponding to a time point at which a point corresponding to this coordinate data was handwritten. The time point at which the point was handwritten may be either an absolute time (e.g. year/month/date/hour/minute/second) or a relative time with reference to a certain time point. For example, an absolute time (e.g. year/month/date/hour/minute/second) at which a stroke began to be handwritten may be added as time stamp information to each stroke data, and furthermore a relative time indicative of a difference from the absolute time may be added as time stamp information T to each coordinate data in the stroke data.

In this manner, by using the time-series information in which the time stamp information T is added to each coordinate data, the temporal relationship between strokes can be more precisely expressed.

Moreover, information (Z) indicative of a pen stroke pressure may be added to each coordinate data.

The time-series information 200 having the structure as described with reference to FIG. 4 can express not only the trace of handwriting of each stroke, but also the temporal relation between strokes. Thus, with the use of the time-series information 200, even if a distal end portion of the handwritten “arrow” is written over the handwritten character “A” or near the handwritten character “A”, as shown in FIG. 3, the handwritten character “A” and the distal end portion of the handwritten “arrow” can be treated as different characters or graphics.

In addition, in the time-series information 200 of the present embodiment, as described above, the arrangement of stroke data SD1, SD2, . . . , SD7 indicates the order of strokes of handwritten characters. For example, the arrangement of stroke data SD1 and SD2 indicates that the stroke of the “Λ” shape was first handwritten and then the stroke of the “-” shape was handwritten. Thus, even when the traces of writing of two handwritten characters are similar to each other, if the orders of strokes of the two handwritten characters are different from each other, these two handwritten characters can be distinguished as different characters.

Furthermore, in the present embodiment, as described above, handwritten data is stored not as an image or a result of character recognition, but as the time-series information 200 which is composed of a set of time-series stroke data. Thus, handwritten characters can be handled, without depending on languages of the handwritten characters. Therefore, the structure of the time-series information 200 of the present embodiment can be commonly used in various countries of the world where different languages are used.

FIG. 5 shows a system configuration of the tablet computer 10.

As shown in FIG. 5, the tablet computer 10 includes a CPU 101, a system controller 102, a main memory 103, a graphics controller 105, a BIOS-ROM 105, a nonvolatile memory 106, a wireless communication device 107, and an embedded controller (EC) 108.

The CPU 101 is a processor which controls the operations of various modules in the tablet computer 10. The CPU 101 executes various kinds of software, which are loaded from the nonvolatile memory 106 that is a storage device into the main memory 103. The software includes an operating system (OS) 201 and various application programs. The application programs include a digital notebook application program 202. The digital notebook application program 202 includes a function of creating and displaying the above-described handwritten page data, a function of editing the handwritten page data, a function of recognizing a handwritten object in the handwritten page data (a handwritten character, a handwritten mark, a handwritten graphic, etc.), and a search function for searching for desired handwritten page data.

In addition, the CPU 101 executes a basic input/output system (BIOS) which is stored in the BIOS-ROM 105. The BIOS is a program for hardware control.

The system controller 102 is a device which connects a local bus of the CPU 101 and various components. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the tablet computer 10. A display signal, which is generated by the graphics controller 104, is sent to the LCD 17A. The LCD 17A displays a screen image based on the display signal. A touch panel 17B and a digitizer 17C are disposed on the LCD 17A. The touch panel 17B is an electrostatic capacitance-type pointing device for executing an input on the screen of the LCD 17A. A contact position on the screen, which is touched by a finger, and a movement of the contact position are detected by the touch panel 17B. The digitizer 17C is an electromagnetic induction-type pointing device for executing an input on the screen of the LCD 17A. A contact position on the screen, which is touched by the pen 100, and a movement of the contact position are detected by the digitizer 17C.

The wireless communication device 107 is a device configured to execute wireless communication such as wireless LAN or 3G mobile communication. The EC 108 is a one-chip microcomputer including an embedded controller for power management. The EC 108 includes a function of powering on or powering off the tablet computer 10 in accordance with an operation of a power button by the user.

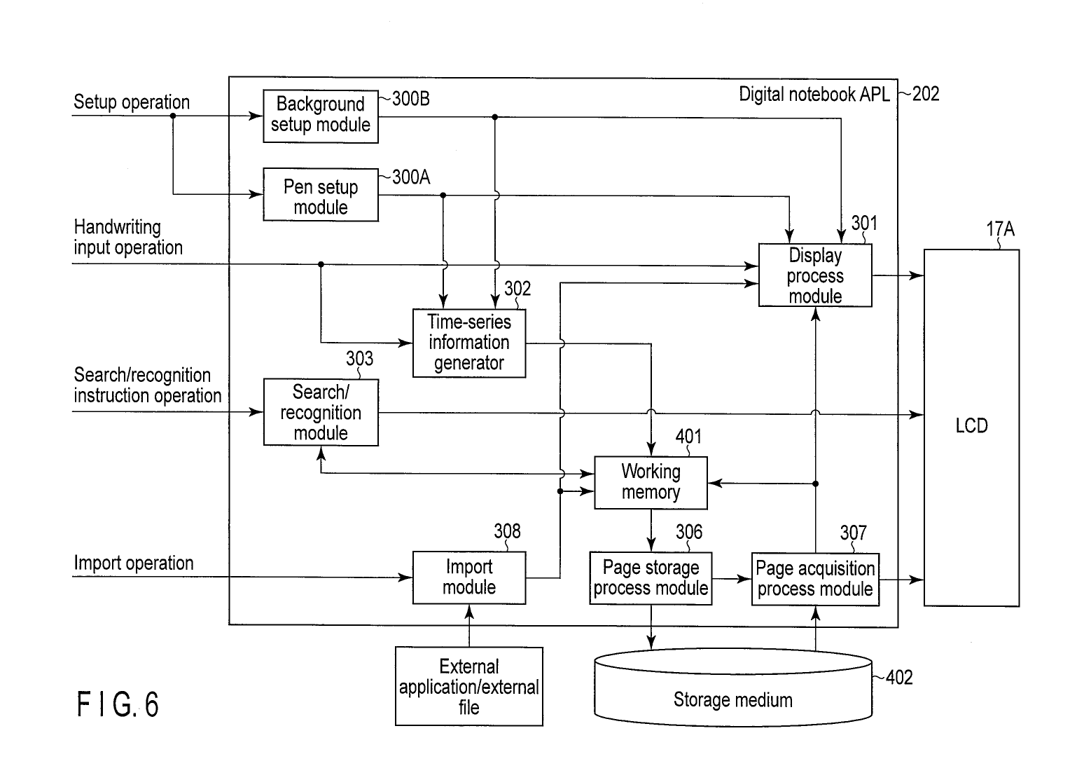

Next, referring to FIG. 6, a description is given of a functional configuration of the digital notebook application program 202.

The digital notebook application program 202 is a WYSIWYG application which can handle handwritten data. The digital notebook application program 202 creates, displays and edits a handwritten document by using coordinate data series (time-series coordinates) which are input by a handwriting input operation with use of the touch-screen display 17. In addition, the digital notebook application program 202 can also search for a handwritten document by using a stroke which has been handwritten as a search key (e.g. a handwritten character or graphic). Furthermore, the digital notebook application program 202 can execute handwriting recognition for converting a character, which has been handwritten on a handwritten document, to a character code.

The digital notebook application program 202 includes, for example, a pen setup module 300A, a background setup module 300B, a display process module 301, a time-series information generator 302, a search/recognition module 303, a page storage process module 306, a page acquisition process module 307, and an import module 308.

The above-described touch-screen display 17 is configured to detect the occurrence of events such as “touch”, “move (slide)” and “release”. The “touch” is an event indicating that an external object has come in contact with the screen. The “move (slide)” is an event indicating that the position of contact of the external object has been moved while the external object is in contact with the screen. The “release” is an event indicating that the external object has been released from the screen.

The digital notebook application program 202 displays on the touch-screen display 17 a note view screen for creating, viewing and editing handwritten page data. On the note view screen, for example, a plurality of pen icons, a “range select” icon, and an “eraser” icon may be displayed. A plurality of kinds of pen styles (drawing styles) are allocated to the plural pen icons. The pen style is determined by, for example, a combination of the color of a line (a locus which is drawn), the kind of line (e.g. solid line, broken line), the thickness of a line, and the kind of penpoint (e.g. ball-point pen, marker, fountain pen).

The pen setup module 300A receives an event of “touch (tap)” which is generated by the touch-screen display 17, thereby detecting a pen change operation. The “touch” event includes coordinates of a contact position. Responding to the reception of the “touch event” on any one of the pen icons, the pen setup module 300A sets the drawing style, which is associated with the touched pen icon, to be the present drawing style.

The background setup module 300B sets up a style (page style) of the background of a handwritten page, in accordance with a background color setup operation which is performed by the user. The style of background includes the color of background, the present/absence of ruled lines which are to be displayed on the background, the interval of ruled lines which are to be displayed on the background, etc.

The display process module 301 and time-series information generator 302 receive an event of “touch”, “move (slide)” or “release”, which is generated by the touch-screen display 17, thereby detecting a handwriting input operation. The “touch” event includes coordinates of a contact position. The “move (slide)” event includes coordinates of a contact position at a destination of movement. Accordingly, the display process module 301 and time-series information generator 302 can receive coordinate series corresponding to the locus of movement of the contact position from the touch-screen display 17.

The display process module 301 is a display processor configured to display a note view screen with the style of background (page style) which has been set by the background setup module 300B. The display process module 301 receives coordinate series from the touch-screen display 17. Then, based on the coordinate series, the display process module 301 displays on the note view screen the locus of each stroke, which is handwritten by the handwriting input operation, with the drawing style (pen style) which has been set by the pen setup module 300A. By the display process module 301, the locus of the pen 100 during a time in which the pen 100 is in contact with the screen, that is, the locus of each stroke, is drawn on the note view screen.

Further, the display process module 301 can display on the note view screen objects corresponding to various content data (image data, audio data, text data, and data created by a drawing application) which are imported from an external application/external file by the import module 308. In this case, the object corresponding to each content data can be disposed at an arbitrary position on the page that is being created.

The time-series information generator 302 receives the above-described coordinate series which are output from the touch-screen display 17, and generates, based on the coordinate series, handwritten data which includes the time-series information having the structure as described in detail with reference to FIG. 4, the information indicative of the pen style that is set up by the pen setup module 300, and the information indicative of the page style that is set up by the background setup module 300B. The time-series information generator 302 temporarily stores the generated handwritten data in a working memory 401.

The search/recognition process module 303 executes a handwriting recognition process of converting a handwritten character string in the handwritten page data to text (character code string), a character recognition process (OCR) of converting a character string included in an image in the handwritten page data to text (character code string), and a speech recognition process of converting a speech included in audio data in the handwritten page data to text. Further, the search/recognition process module 303 can search for desired handwritten page data from many handwritten page data, by using a text search method.

The page storage process module 306 generates handwritten page data including plural kinds of content data (handwritten data, and other various content data) which are disposed on the page that is being created, and stores the handwritten page data in a storage medium 402. The handwritten page data is stored in the storage medium 402 as a file described in a markup language, for example, an XML file. The storage medium 402 may be, for example, the storage device in the tablet computer 10, or the storage device in the server computer 2. The file of handwritten page data includes a plurality of pieces of layer information corresponding to a plurality of kinds of content data (handwritten data, image data, audio data, text data, and data created by a drawing application) included in the handwritten page data. The layer information corresponding to each content data includes not only a substance (object) of the content data, but also a character string (text) corresponding to the content data. Thereby, even when a substance of a new type of content data, which cannot be handled by an application program of an old version, is included in handwritten page data, the application program of the old version can display on the screen the text which corresponds to the substance of the new type of content data.

The page acquisition process module 307 acquires arbitrary handwritten page data (file) from the storage medium 402. The acquired handwritten page data is sent to the display process module 301. The display process module 301 displays on the screen a page on which plural kinds of data (handwritten data, and other content data) included in the handwritten page data are disposed.

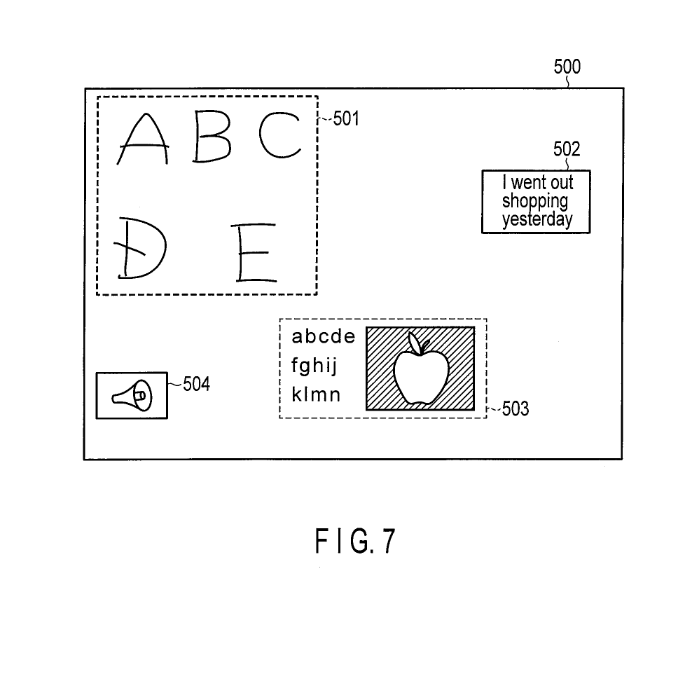

FIG. 7 is a view illustrating an example of a handwritten page 500 which is displayed on the note view screen.

This handwritten page 500 includes four layers, namely a handwriting layer 501, a text layer 502, an image layer 503 and an audio layer 504. The handwriting layer 501 is a layer for displaying content (handwritten strokes) corresponding to handwritten data. The text layer 502 is a layer for displaying text which is content data that is different in kind of content from the handwritten data. The image layer 503 is a layer for displaying image content which is content data that is different in kind of content from the handwritten data and the text. The audio layer 504 is a layer for displaying content corresponding to audio data which is content data that is different in kind of content from the handwritten data, text and image data. The sizes of these layers are variable, and each layer may be displayed with an arbitrary size at an arbitrary position on the handwritten page 500. One layer may overlap another layer. A file of handwritten data corresponding to the handwritten page 500 includes four pieces of layer information corresponding to the four layers (handwriting layer 501, text layer 502, image layer 503 and audio layer 504). Based on the four pieces of layer information, the display process module 301 displays a page, on which plural kinds of data (handwritten data, text, image, and audio) are disposed, on the screen. An image (icon) corresponding to audio data may be displayed on an area on the page, which corresponds to the audio layer 504.

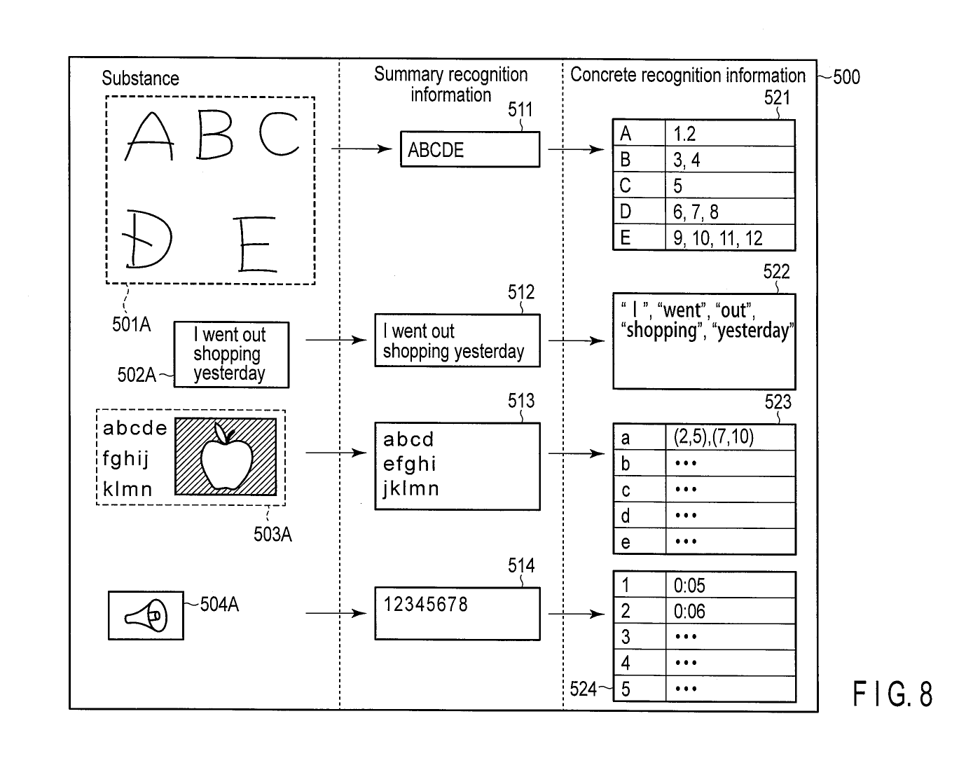

FIG. 8 shows an example of the data structure of handwritten page data corresponding to the handwritten page 500 of FIG. 7.

In the handwritten page data of the present embodiment, a plurality of mutually different pieces of layer information, which correspond to plural kinds of content data included in the handwritten page data, are defined in order to secure forward compatibility of the handwritten page data. Each layer information includes a plurality of layer information storage portions which are divided from each other. In general terms, each layer information includes a layer information storage portion for storing abstraction layer information, and a layer information storage portion for storing concrete layer information. The abstraction layer information includes, for example, information which designates a display area of a layer. For example, the layer information corresponding to the handwriting layer 501 includes information designating the display area (display position, size) on the page 500 as the abstraction layer information.

The concrete layer information includes, for example, a substance (object) of content data. For example, the layer information corresponding to the handwriting layer 501 includes, as concrete layer information (substance) 501A, handwritten data including a plurality of stroke data corresponding to a plurality of handwritten strokes which are to be displayed on the display area of the handwriting layer 501. The layer information corresponding to the text layer 502 includes, as concrete layer information (substance) 502A, a character code string corresponding to text which is to be displayed on the display area of the text layer 502. The layer information corresponding to the image layer 503 includes, as concrete layer information (substance) 503A, information for displaying an image which is to be displayed on the display area of the image layer 503, for example, image data itself, or information indicative of a path of this image data. The layer information corresponding to the audio layer 504 includes, as concrete layer information (substance) 504A, audio data itself that is to be played back when the audio layer 504 is selected, or information indicative of a path of this audio data. Further, the layer information corresponding to the audio layer 504 may also include, as concrete layer information (substance) 504A, information for displaying an image (icon) which is to be displayed on the display area of the audio layer 504, for example, an image (icon) itself, or information indicative of a path of this image (icon).

For example, the case is now assumed that the image layer 503 is newly added in accordance with the version upgrade of the digital notebook application program 202. There is a case in which the digital notebook application program of the old version is unable to understand the format of the concrete layer information (substance) 503A of the image layer 503. However, in the layer information corresponding to the image layer 503, since the abstraction layer information designating the display area and the concrete layer information (substance) 503A are separately stored, the digital notebook application program of the old version (i.e. the old application program) is able to understand at least the presence of the layer corresponding to the image layer 503, and is able to understand the display area of this layer. Although the old application program is unable to display the image corresponding to the image layer 503 on the page, the old application program can at least display a frame surrounding the display area corresponding to the image layer 503, or can display a character string, which is included in summary recognition information (to be described later), on the display area corresponding to the image layer 503. Furthermore, since the image layer 503 and handwriting layer 501 are described as different pieces of layer information, even if the layer information corresponding to the image layer 503 is added, this does not alter the format of the layer information corresponding handwriting layer 501. Therefore, even the old application program can normally handle the layer information corresponding to the handwriting layer 501.

Each layer information further includes a layer information storage portion (recognition information storage portion) for storing recognition information corresponding to content data in this layer information. In order to secure forward compatibility, the recognition information is also divided into summary recognition information and concrete recognition information, and stored. The summary recognition information includes a character string corresponding to content data. The summary recognition information is recognition information having a common format among plural kinds of content data. In short, the format of the summary recognition information is identical in all layer information. The format (also referred to as “data format”), in this context, means a data/information description format, a data arrangement, a data structure, etc.

The concrete recognition information is more specific recognition information. The concrete recognition information in each layer information has a data format corresponding to the kind of content data. In order to separately store the summary recognition information and concrete recognition information, the recognition information storage portion includes a summary recognition information storage portion for storing the summary recognition information and a concrete recognition information storage portion for storing the concrete recognition information.

The layer information corresponding to the handwriting layer 501 includes a character string (ABODE in this example) corresponding to handwritten data as summary recognition information 511. The summary recognition information 511 can be obtained by executing the above-described handwriting recognition. The layer information corresponding to the handwriting layer 501 further includes concrete recognition information 521.

The concrete recognition information 521 is additional information which can be added, where necessary, in accordance with version upgrade of the digital notebook application program 202. The concrete recognition information 521 is information for associating each character included in the character string, which corresponds to the handwritten data, and stroke data in the handwritten data. To be more specific, the concrete recognition information 521 indicates which stroke in the handwritten data constitutes each character which is obtained by recognizing the handwritten data. In this example, the concrete recognition information 521 includes five items corresponding to five recognized characters. With respect to each item, the concrete recognition information 521 indicates a character code (text) of the recognized character and information (stroke ID) for identifying at least one stroke data corresponding to this recognized character. For example, the information corresponding to the first item includes information indicative of the character code (text) of the recognized character “A” and information indicative of stroke ID=1 and ID=2 for identifying two stroke data constituting the character “A”.

The layer information corresponding to the text layer 502 includes a character string corresponding to text data of the text layer 502 as summary recognition information 512. The layer information corresponding to the text layer 502 further includes concrete recognition information 522.

The concrete recognition information 522 is additional information which can be added, where necessary, in accordance with version upgrade of the digital notebook application program 202. The concrete recognition information 522 is information for distinctively showing, in units of a word, the character string included in the text data of the text layer 502. This concrete recognition information 522 can be obtained by executing morphological analysis of the text data of the text layer 502.

The layer information corresponding to the image layer 503 includes a character string (abcdefghijklmn, in this example) corresponding to image data as summary recognition information 513. The summary recognition information 513 is obtained, for example, by executing character recognition (OCR recognition) of a character image included in the image data. The layer information corresponding to the image layer 503 further includes concrete recognition information 523.

The concrete recognition information 523 is additional information which can be added, where necessary, in accordance with version upgrade of the digital notebook application program 202. The concrete recognition information 523 is information for associating each character included in the character string, which corresponds to the image data, and a data portion in the image data. To be more specific, the concrete recognition information 523 indicates at which data portion in the image data each character, which is obtained by recognizing the image, exists. In this example, the concrete recognition information 523 includes 14 items corresponding to 14 recognized characters “abcdefghijklmn” (in FIG. 8, only five items corresponding to five characters “abcde” are illustrated for the purpose of simple description). With respect to each item, the concrete recognition information 523 indicates a character code (text) of the recognized character and the upper left apex and lower right apex of a circumscribed rectangle surrounding this recognized character. For example, the information corresponding to the first item includes information indicative of the character code (text) of the recognized character “a” and information indicative of the upper left apex (2, 5) and lower right apex (7, 10) of a circumscribed rectangle surrounding this recognized character “a”.

The layer information corresponding to the audio layer 504 includes as summary recognition information 514 a character string (12345678, in this example) which is obtained by executing a speech recognition process of converting a speech included in audio data to text. The layer information corresponding to the audio layer 504 further includes concrete recognition information 524.

The concrete recognition information 524 is additional information which can be added, where necessary, in accordance with version upgrade of the digital notebook application program 202. The concrete recognition information 524 is information for associating each character included in the character string, which corresponds to the audio data, and a temporal position in the audio data. To be more specific, the concrete recognition information 524 indicates how many seconds after the start time point of playback of the audio data the speech portion corresponding to each character is played back.

The character strings corresponding to the pieces of summary recognition information, 511 to 514, can be used in order to search for the handwritten page data by a text search method. In addition, the concrete recognition information 521 corresponding to the handwriting layer 501 can be used in order to specify at least one first stroke data in the handwritten data, which corresponds to the first character that is the search key. Besides, the concrete recognition information 523 corresponding to the image layer 503 can be used in order to specify a first data portion in the image data, which corresponds to the first character that is the search key.

As described above, in the handwritten page data in the embodiment, in any of content data, summary recognition information and concrete recognition information are separately stored. Thus, if each application program recognizes the format of the summary recognition information that is the abstraction recognition information, the application program can handle the character string corresponding to each content data, even if the application program does not recognize the format of the concrete recognition information.

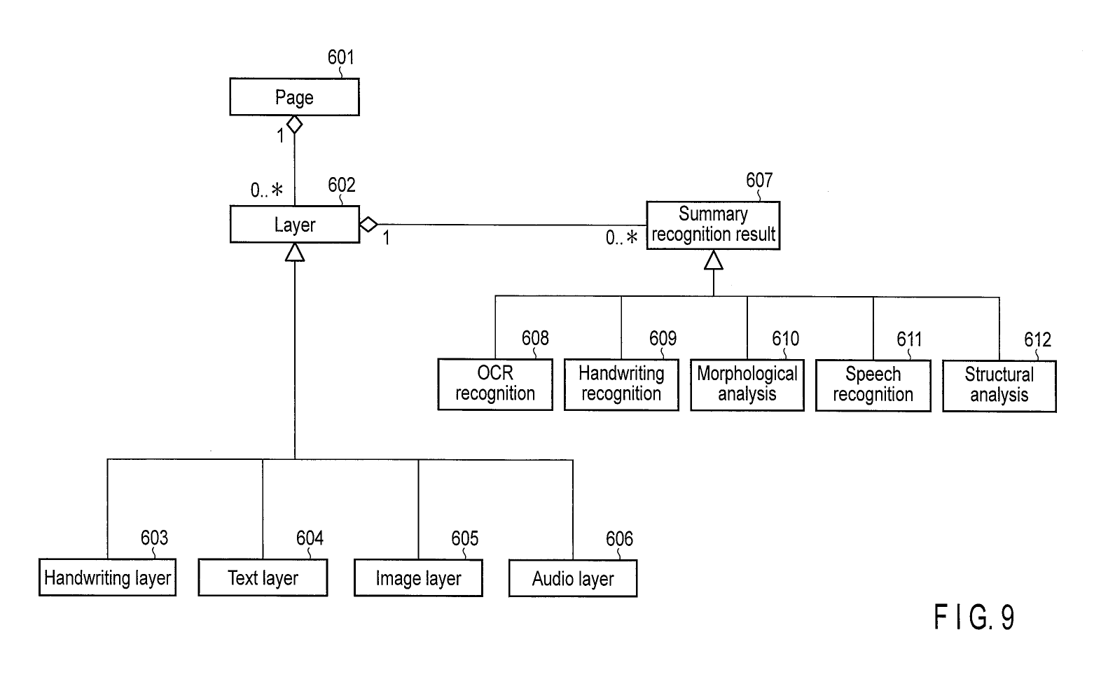

FIG. 9 illustrates an example of a class diagram (UML class diagram) corresponding to the data structure of FIG. 8.

In this UML class diagram, the following classes are defined: a page class 601, a layer class 602, a handwriting layer class 603, a text layer class 604, an image layer class 605, an audio layer class 606, a summary recognition result class 607, an OCR recognition result class 608, a handwriting recognition result class 609, a morphological analysis class 610, a speech recognition class 611 and a structural analysis class 612.

The page class 601 corresponds to one handwritten page. An association between the page class 601 and the layer class 602 expresses that one page includes 0 or more layer(s). In addition, the layer class 602 is an abstraction class (super-class) for grouping the handwriting layer class 603, text layer class 604, image layer class 605 and audio layer class 606.

The handwriting layer class 603 is a layer information storage portion for storing the concrete layer information (substance) 501A of the handwriting layer 501. The text layer class 604 is a layer information storage portion for storing the concrete layer information (substance) 502A of the text layer 502. The image layer class 605 is a layer information storage portion for storing the concrete layer information (substance) 503A of the image layer 503. The audio layer class 606 is a layer information storage portion for storing the concrete layer information (substance) 504A of the audio layer 504.

In addition, one layer class 602 includes 0 or more summary recognition result class(es) 607. The summary recognition result class 607 is the above-described recognition information storage portion. Besides, the summary recognition result class 607 is an abstraction class (super-class) for grouping the OCR recognition result class 608, handwriting recognition result class 609, morphological analysis class 610, speech recognition class 611 and structural analysis class 612.

The OCR recognition result class 608 is a concrete recognition information storage portion for storing the above-described concrete recognition information 523. The handwriting recognition result class 609 is a concrete recognition information storage portion for storing the above-described concrete recognition information 521. The morphological analysis class 610 is a concrete recognition information storage portion for storing the above-described concrete recognition information 522. The speech recognition class 611 is a concrete recognition information storage portion for storing the above-described concrete recognition information 524. The structural analysis class 612 is used for storing other concrete recognition information.

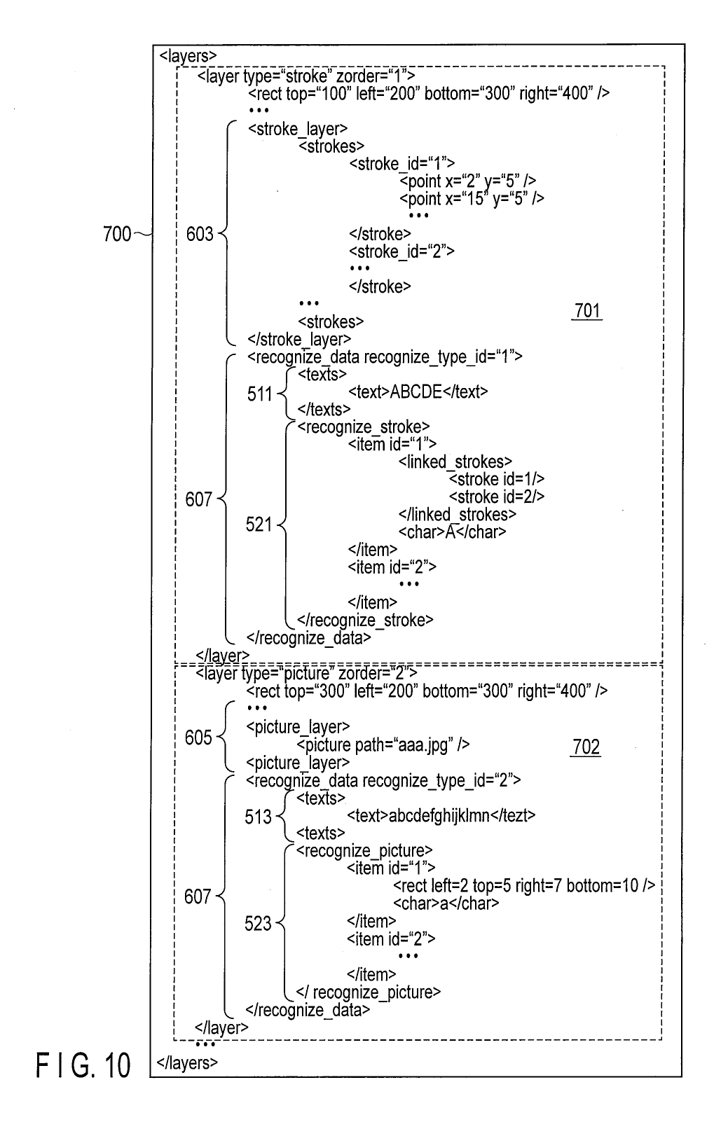

FIG. 10 illustrates an example of an XML file 700 corresponding to the handwritten page of FIG. 7.

The XML file 700 includes a plurality of “layer” elements corresponding to the above-described plural pieces of layer information. These “layer” elements are elements having a relationship of brothers.

A “layer” element 701 is a “layer” element corresponding to the handwriting layer 501. An attribute value (type=“stroke”) included in the “layer” element 701 indicates that this layer element 701 corresponds to a handwriting layer (stroke layer). An attribute value (zorder=“1”) included in the “layer” element 701 indicates that this layer element 701 is a layer which is to be disposed on a foremost foreground plane.

The “layer” element 701 includes a “rect” element, a “stroke_layer” element, and a “recognize_data” element.

The “rect” element is an information storage portion for storing information for designating the display area of the layer (handwriting layer 501) corresponding to the “layer” element 701. An attribute value (top=“100” left=“200” bottom=“300” right=“400”) in the “rect” element specifies the upper left apex (top=“100” left=“200”) of the handwriting layer 501 and the lower right apex (bottom=“300” right=“400”) of the handwriting layer 501.

The “rect” element is layer information which is abstracted, and is a data field having a common data format among all layers, i.e. among all kinds of content data.

The “stroke_layer” element is an information storage portion for storing handwritten data. In this “stroke_layer” element, handwritten data is described. The “stroke_layer” element corresponds to the above-described handwriting layer class 603. The “stroke_layer” element includes a “strokes” element, and a plurality of “stroke” elements which are child elements of the “strokes” element.

In a “stroke” element with an attribute value (id=“1”), stroke data of stroke id=1 is described. The “stroke” element with the attribute value (id=“1”) includes a plurality of “point” elements corresponding to a plurality of points included in the stroke data of the stroke id=1. Each “point” element is indicative of coordinates of a corresponding point.

A “recognize_data” element in the “layer” element 701 is a node for aggregating (grouping) the summary recognition information 511 (character string) and the concrete recognition information 521. This “recognize_data” element corresponds to the summary recognition result class 607 of FIG. 9.

The “recognize_data” element in the “layer” element 701 includes two child elements, namely a “texts” element and a “recognize_stroke” element.

In the “texts” element, the character string of the summary recognition information 511 is described. The “texts” element is layer information which is abstracted, and is a data field having a common data format among all layers, i.e. among all kinds of content data.

In the “recognize_stroke” element, the concrete recognition information 521 is described.

A “layer” element 702 is a “layer” element corresponding to the image layer 503. An attribute value (type=“picture”) included in the “layer” element 702 indicates that this layer element 702 corresponds to an image layer (picture layer). An attribute value (zorder=“2”) included in the “layer” element 702 indicates that this layer element 702 is the second from above in the order of display.

The “layer” element 702 includes a “rect” element, a “picture_layer” element, and a “recognize_data” element.

The “rect” element is an information storage portion for storing information for designating the display area of the layer (image layer 503) corresponding to the “layer” element 702. An attribute value (top=“300” left=“200” bottom=“500” right=“400”) in the “rect” element specifies the upper left apex (top=“300” left=“200”) of the image layer 503 and the lower right apex (bottom=“500” right=“400”) of the image layer 503. The “rect” element of the “layer” element 702 and the “rect” element of the “layer” element 701 are described in the common format.

The “picture_layer” element is an element in which information for displaying image data is described, and corresponds to the above-described image layer class 605. The “picture_layer” element includes, for example, a “picture” element which is indicative of a path of image data.

A “recognize_data” element in the “layer” element 702 is a node for aggregating (grouping) the summary recognition information 513 (character string) and the concrete recognition information 523. This “recognize_data” element corresponds to the summary recognition result class 607 of FIG. 9.

The “recognize_data” element in the “layer” element 702 includes two child elements, namely a “texts” element and a “recognize_picture” element. In the “texts” element, the character string of the summary recognition information 513 is described. In the “recognize_picture” element, the concrete recognition information 523 is described. The content of the “texts” element in the “layer” element 702 and the content of the “texts” element of the “layer” element 701 are also described in the common format.

As described above, in the handwritten page data of the embodiment, layers are defined in accordance with kinds of media (kinds of content data) in order to secure compatibility. As regards layer information corresponding to each layer, there are prepared the abstract data field having a common data format among the kinds of media and the concrete data field having a data format corresponding to each kind of media. Thus, even if unknown media data is added to handwritten page data, each application program can recognize at least that the unknown media data is one of layers, and can normally process each of the other media data in the handwritten page data. Furthermore, since the summary recognition information having the common data format among the kinds of media is stored in each layer information, even if a data format of unknown concrete recognition information is added and this concrete recognition information cannot be handled, each application program can execute analysis (meta-information analysis) of handwritten page data by using the summary recognition information.

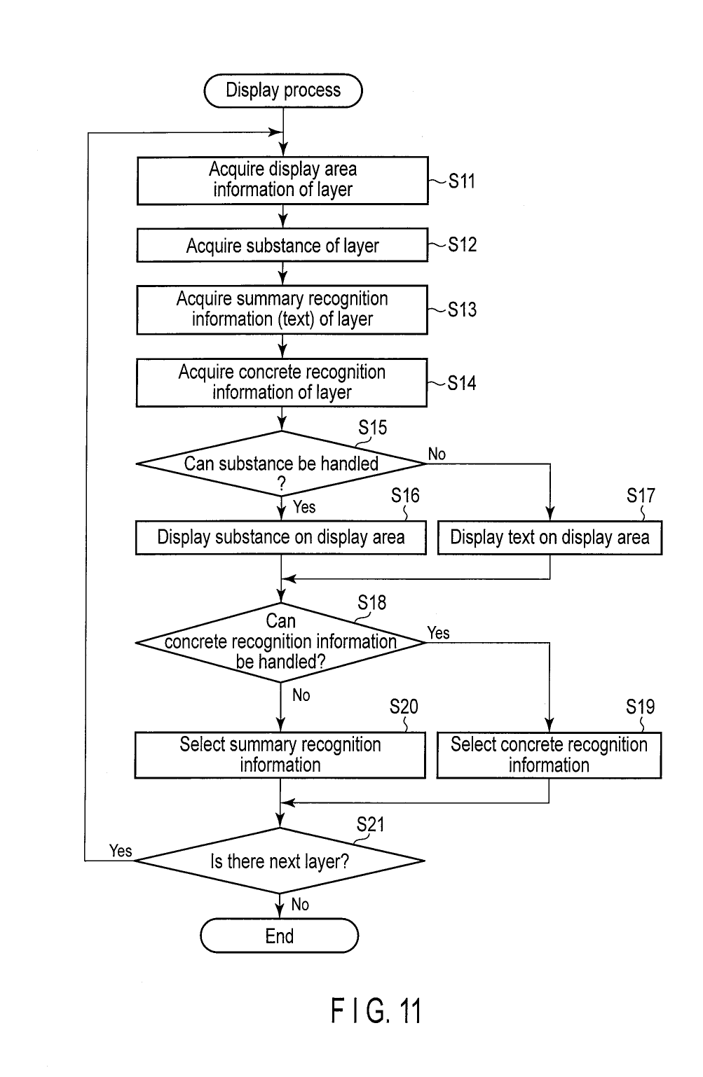

FIG. 11 illustrates the procedure of a display process which is executed by the digital notebook application program 202.

The digital notebook application program 202 acquires a file (handwritten page data) from the storage medium of the electronic device 10, the personal computer 1, or the server 2. Then, from the first layer information of this file, the digital notebook application program 202 acquires the information (display area information) designating the display area of the layer, the substance (content data) of the layer, the summary recognition information and the concrete recognition information (steps S11 to S14).

If the digital notebook application program 202 can handle this substance (content data) (YES in step S15), the digital notebook application program 202 displays the content data on the area on the page, which is designated by the display area information (step S16).

On the other hand, if the digital notebook application program 202 is unable to handle this substance (content data) (NO in step S15), the digital notebook application program 202 displays the text in the summary recognition information on the area on the page, which is designated by the display area information (step S17). Alternatively, the digital notebook application program 202 may skip the execution of the process of displaying the substance (content data).

If the digital notebook application program 202 can handle the concrete recognition information (YES in step S18), the digital notebook application program 202 selects this concrete recognition information as usable recognition information (step S19). On the other hand, if the digital notebook application program 202 is unable to handle the concrete recognition information (NO in step S18), the digital notebook application program 202 selects the summary recognition information as usable recognition information (step S20).

Next, the digital notebook application program 202 determines whether there is layer information which has not yet been processed (step S21). Until there remains no layer information which is yet to be processed, the digital notebook application program 202 repeatedly executes the above-described process of steps S11 to S20.

As has been described above, in the present embodiment, a file including a plurality of pieces of layer information corresponding to plural kinds of data is acquired. Based on the plural pieces of layer information included in this file, a page on which plural kinds of data are disposed is displayed on the screen. This file includes at least first layer information and second layer information. The first layer information includes handwritten data including a plurality of stroke data, a first character string corresponding to the plural stroke data, and first information designating a first display area on a page, which corresponds to the first layer information. The second layer information includes information for displaying content data which differs in kind of content from the handwritten data, a second character string corresponding to the content data, and second information designating a second display area on the page, which corresponds to the second layer information. By storing in each layer information the substance of data (handwritten data, and information for displaying content data), the information designating the display area and the character string, even when a new type of content data of an unknown format has been added to the file, each application program can at least recognize that the unknown content data is one of layers, and can display, where necessary, a character string corresponding to the unknown content data on the display area.

Therefore, forward compatibility can be secured, and handwritten data can easily be handled.

Since the various processes in the embodiment can be realized by a computer program, the same advantageous effects as with the present embodiment can easily be obtained simply by installing the computer program into an ordinary computer through a computer-readable storage medium which stores the computer program, and executing the computer program.

In the embodiment, although XML has been taken as an example of the markup language, handwritten page data may be described by using a markup language different from XML. In addition, handwritten page data may be described by using JSON.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processor configured to acquire a file comprising layer information; and
a display processor configured to display a page on a screen, based on the layer information,
wherein the file comprises at least first layer information and second layer information,
the first layer information comprises handwritten data including a plurality of stroke data, a first character string corresponding to the plurality of stroke data, and first information designating a first display area on the page, the first character string or the plurality of the stroke data displayed on the first display area, and
the second layer information comprises information for displaying content data which differs in kind of content from the handwritten data, a second character string corresponding to the content data, and second information designating a second display area on the page, the second character string or the content data displayed on the second display area.

2. The electronic device of claim 1, wherein the display processor is further configured to display the plurality of stroke data, or the first character string, on the first display area on the page, and to display the content data or the second character string on the second display area on the page.

3. The electronic device of claim 1, wherein the first information and the second information are described in a mutually common format, and the first character string and the second character string are described in a mutually common format.

4. The electronic device of claim 1, wherein the first layer information further comprises first additional information for associating each of characters included in the first character string with stroke data in the plurality of stroke data, and
the second layer information further comprises second additional information for associating each of characters included in the second character string with a data portion in the content data.

5. The electronic device of claim 4, wherein the first additional information is usable for specifying at least one first stroke data in the handwritten data, the at least one first stroke data corresponding to a first character which is a search key, and the second additional information is usable for specifying a first data portion in the content data, the first data portion corresponding to the first character.

6. The electronic device of claim 1, wherein the first layer information comprises first, second and third information storage portions which are mutually divided, the first information storage portion comprising the first information, the second information storage portion comprising the handwritten data, and the third information storage portion comprising the first character string, and
the second layer information comprises fourth, fifth and sixth information storage portions which are mutually divided, the fourth information storage portion being a data field having the same format as the first information storage portion, the sixth information storage portion being a data field having the same format as the third information storage portion, the fourth information storage portion comprising the second information, the fifth information storage portion comprising the information for displaying the content data, and the sixth information storage portion comprising the second character string.

7. The electronic device of claim 6, wherein the first layer information further comprises first additional information for associating each of characters included in the first character string with stroke data in the plurality of stroke data,
the second layer information further comprises second additional information for associating each of characters included in the second character string with a data portion in the content data,
the third information storage portion comprises two information storage portions which are mutually divided, one of the information storage portions in the third information storage portion comprising the first character string, and the other of the information storage portions in the third information storage portion comprising the first additional information,
the sixth information storage portion comprises two information storage portions which are mutually divided, one of the information storage portions in the sixth information storage portion comprising the second character string, and the other of the information storage portions in the sixth information storage portion comprising the second additional information, and
said one of the information storage portions in the sixth information storage portion is a data field having the same format as said one of the information storage portions in the third information storage portion.

8. The electronic device of claim 1, wherein the file is described in a markup language,
the first layer information and the second layer information are described in a first element and a second element, respectively, which have a relationship of brothers,
the first element comprises a third element in which the first information is described, a fourth element in which the handwritten data is described, and a fifth element in which the first character element is described, and
the second element comprises a sixth element which has the same data format as the third element and in which the second information is described, a seventh element in which the information for displaying the content data is described, and an eighth element which has the same data format as the fifth element and in which the second character string is described.

9. A method of processing data, comprising:
acquiring a file comprising layer information; and
displaying a page on a screen, based on the layer information,
wherein the file comprises at least first layer information and second layer information,
the first layer information comprises handwritten data including a plurality of stroke data, a first character string corresponding to the plurality of stroke data, and first information designating a first display area on the page, the first character string or the plurality of the stroke data displayed on the first display area, and
the second layer information comprises information for displaying content data which differs in kind of content from the handwritten data, a second character string corresponding to the content data, and second information designating a second display area on the page, the second character string or the content data displayed on the second display area.

10. The method of claim 9, further comprising:
displaying the plurality of stroke data, or the first character string, on the first display area on the page, and
displaying the content data or the second character string on the second display area on the page.

11. The method of claim 9, wherein the first information and the second information are described in a mutually common format, and the first character string and the second character string are described in a mutually common format.

12. The method of claim 9, wherein the first layer information further comprises first additional information for associating each of characters included in the first character string with stroke data in the plurality of stroke data, and
the second layer information further comprises second additional information for associating each of characters included in the second character string with a data portion in the content data.

13. The method of claim 12, wherein the first additional information is usable for specifying at least one first stroke data in the handwritten data, the at least one first stroke data corresponding to a first character which is a search key, and the second additional information is usable for specifying a first data portion in the content data, the first data portion corresponding to the first character.

14. The method of claim 9, wherein the first layer information comprises first, second and third information storage portions which are mutually divided, the first information storage portion comprising the first information, the second information storage portion comprising the handwritten data, and the third information storage portion comprising the first character string, and
the second layer information comprises fourth, fifth and sixth information storage portions which are mutually divided, the fourth information storage portion being a data field having the same format as the first information storage portion, the sixth information storage portion being a data field having the same format as the third information storage portion, the fourth information storage portion comprising the second information, the fifth information storage portion comprising the information for displaying the content data, and the sixth information storage portion comprising the second character string.

15. The method of claim 14, wherein the first layer information further comprises first additional information for associating each of characters included in the first character string with stroke data in the plurality of stroke data,
the second layer information further comprises second additional information for associating each of characters included in the second character string with a data portion in the content data,
the third information storage portion comprises two information storage portions which are mutually divided, one of the information storage portions in the third information storage portion comprising the first character string, and the other of the information storage portions in the third information storage portion comprising the first additional information,
the sixth information storage portion comprises two information storage portions which are mutually divided, one of the information storage portions in the sixth information storage portion comprising the second character string, and the other of the information storage portions in the sixth information storage portion comprising the second additional information, and
said one of the information storage portions in the sixth information storage portion is a data field having the same format as said one of the information storage portions in the third information storage portion.

16. The method of claim 9, wherein the file is described in a markup language,
the first layer information and the second layer information are described in a first element and a second element, respectively, which have a relationship of brothers,
the first element comprises a third element in which the first information is described, a fourth element in which the handwritten data is described, and a fifth element in which the first character element is described, and
the second element comprises a sixth element which has the same data format as the third element and in which the second information is described, a seventh element in which the information for displaying the content data is described, and an eighth element which has the same data format as the fifth element and in which the second character string is described.

17. A computer-readable, non-transitory storage medium having stored thereon a computer program which is executable by a computer, the computer program controlling the computer to execute functions of:
acquiring a file comprising layer information; and
displaying on a screen a page based on the layer information,
wherein the file comprises at least first layer information and second layer information,
the first layer information comprises handwritten data including a plurality of stroke data, a first character string corresponding to the plurality of stroke data, and first information designating a first display area on the page, the first character string or the plurality of the stroke data displayed on the first display area, and
the second layer information comprises information for displaying content data which differs in kind of content from the handwritten data, a second character string corresponding to the content data, and second information designating a second display area on the page, the second character string or the content data displayed on the second display area.

18. The storage medium of claim 17, wherein the computer program further controls the computer to execute functions of:
displaying the plurality of stroke data, or the first character string, on the first display area on the page, and
displaying the content data or the second character string on the second display area on the page.

19. The storage medium of claim 17, wherein the first information and the second information are described in a mutually common format, and the first character string and the second character string are described in a mutually common format.

20. The storage medium of claim 17, wherein the first layer information further comprises first additional information for associating each of characters included in the first character string with stroke data in the plurality of stroke data, and
the second layer information further comprises second additional information for associating each of characters included in the second character string with a data portion in the content data.

21. The storage medium of claim 20, wherein the first additional information is usable for specifying at least one first stroke data in the handwritten data, the at least one first stroke data corresponding to a first character which is a search key, and the second additional information is usable for specifying a first data portion in the content data, the first data portion corresponding to the first character.

22. The storage medium of claim 17, wherein the first layer information comprises first, second and third information storage portions which are mutually divided, the first information storage portion comprising the first information, the second information storage portion comprising the handwritten data, and the third information storage portion comprising the first character string, and
the second layer information comprises fourth, fifth and sixth information storage portions which are mutually divided, the fourth information storage portion being a data field having the same format as the first information storage portion, the sixth information storage portion being a data field having the same format as the third information storage portion, the fourth information storage portion comprising the second information, the fifth information storage portion comprising the information for displaying the content data, and the sixth information storage portion comprising the second character string.

23. The storage medium of claim 22, wherein the first layer information further comprises first additional information for associating each of characters included in the first character string with stroke data in the plurality of stroke data,
the second layer information further comprises second additional information for associating each of characters included in the second character string with a data portion in the content data,
the third information storage portion comprises two information storage portions which are mutually divided, one of the information storage portions in the third information storage portion comprising the first character string, and the other of the information storage portions in the third information storage portion comprising the first additional information,
the sixth information storage portion comprises two information storage portions which are mutually divided, one of the information storage portions in the sixth information storage portion comprising the second character string, and the other of the information storage portions in the sixth information storage portion comprising the second additional information, and
said one of the information storage portions in the sixth information storage portion is a data field having the same format as said one of the information storage portions in the third information storage portion.

24. The storage medium of claim 17, wherein the file is described in a markup language,
the first layer information and the second layer information are described in a first element and a second element, respectively, which have a relationship of brothers,
the first element comprises a third element in which the first information is described, a fourth element in which the handwritten data is described, and a fifth element in which the first character element is described, and
the second element comprises a sixth element which has the same data format as the third element and in which the second information is described, a seventh element in which the information for displaying the content data is described, and an eighth element which has the same data format as the fifth element and in which the second character string is described.
